(19) United States
(12) Patent Application Publication
(10) Pub. No.: US 2013/0162842 A1
(43) Pub. Date: Jun. 27, 2013

(54) IMAGE CAPTURE

(71) Applicants: Adam Anthony Greyson, Boise, ID (US); Curt N. Van Lydegraf, Eagle, ID (US)

(72) Inventors: Adam Anthony Greyson, Boise, ID (US); Curt N. Van Lydegraf, Eagle, ID (US)

(21) Appl. No.: 13/333,275

(22) Filed: Dec. 21, 2011

(51) Int. Cl. H04N 5/225

(52) U.S. Cl. 348/207.1; 348/E05.024

(57) ABSTRACT

Embodiments provide methods, apparatuses, and articles of manufacture which enable a client device to establish a communication link with a photographic device for the purpose of capturing an image. The client device and the photographic device may exchange synchronization data via the communication link. In one embodiment, the client device may then obtain a portion of the image generated by the photographic device.

### BACKGROUND

Image capturing devices are becoming more pervasive in society. Such devices, which include handheld mobile phones, cameras, and smart phones, among others, may have various image capture capabilities. These image capture capabilities may be limited in comparison to application specific devices. For example, a camera (e.g., image sensor & lens) on a smart phone may be incapable of generating a panoramic or three-dimensional (3D) image while application specific devices (i.e., wide angle lens, stereoscopic lens) are not so limited.

### BRIEF DESCRIPTION OF THE DRAWINGS

FIG. 1 illustrates a block diagram of an apparatus in accordance with an example of the present invention;

FIG. 2 illustrates a block diagram of synchronization data in accordance with an example of the present disclosure;

FIG. 3 illustrates an example of multiple devices cooperatively communicating to generate photographic data;

FIG. 4 illustrates an example of multiple devices cooperatively communicating to generate a stereoscopic image;

FIG. 5 illustrates an example of a stereoscopic image generated via cooperative communication between multiple devices;

FIG. 6 illustrates an example display of a device utilizing an alignment aid to generate photographic data; and

FIGS. 7-10 illustrate example flow diagrams in accordance with the present disclosure.

### DETAILED DESCRIPTION

Client devices including, but not limited to, mobile phones, smart phones, notebook computers, desktop computers, and cameras may include varying image capturing capabilities. These capabilities may include varying resolutions, apertures, shutter speeds, and video capabilities, among others. Because of these capabilities, a client device may be incapable of generating various types of images. For example, a client device's shutter speed may prevent the client device from generating multiple photos within a short period of time. This may impact an ability to capture multiple images of a moving subject. As another example, a client device may be incapable of taking stereoscopic images. A stereoscopic image is an image that enables a user to perceive a three-dimensional (3D) representation of the subject within the image.

In the present disclosure, methods, systems, and articles of manufacture are disclosed which enable client devices to communicate and cooperatively generate images and/or videos that the individual client devices may be incapable of generating independently. Throughout the remainder of the present disclosure, reference is made to client devices and photographic devices. Client devices and photographic devices may be similar or different devices; the distinction is merely for ease in explaining and understanding various examples. In other words, client devices and photographic devices may be selected from a group including, but not limited to, mobile phones, smart phones, notebook computers, desktop computers, and cameras, among others.

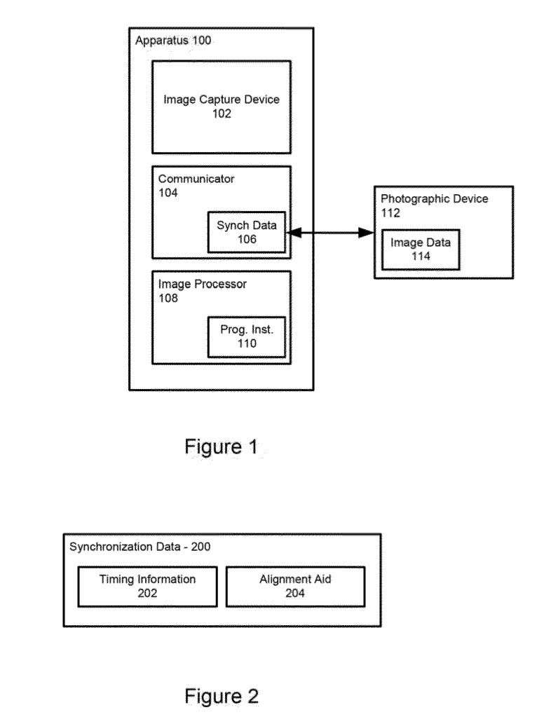

Referring to FIG. 1, an apparatus is illustrated in accordance with present disclosure. The apparatus 100 may be a client device or a photographic device. The apparatus 100 includes an image capture device 102, a communicator 104, and an image processor 108. The apparatus 100 is communicate with various devices 112 (e.g., client devices, photographic devices) to generate various images and/or videos.

In the illustrated example, image capture device 102 is a device configured to generate image data. Image data, as used herein, is any data captured by a device that represents, in digital form, an object (e.g., person, item, location, etc.). Examples of image capture devices 102 may include cameras or video cameras having image sensors, lenses, and shutters, among other elements. The image capture device 102 may have predetermined characteristics that define its capabilities.

In the illustrated example, communicator 104 is coupled to the image capture device 102, and is configured to communicate synchronization data 106 to a photographic device 112 and to receive image data 114 from the photographic device 112 based on the synchronization data 106. Synchronization data 106 is data that facilitates or enables a device 112 to generate an image or image data 114 in a cooperative manner.

Synchronization data 106, as illustrated more clearly in FIG. 2, may include, in various examples, timing information 202 and/or alignment aids 204. Timing information 202 may include information indicating when the photographic device 112 is to generate the image represented by image data 114. Timing information 202 can include an indication that a device 112 receiving the synchronization data 106 is to take a picture at a certain time with reference to a clock, within a predetermined amount of time, or upon a determination that the photographic device 112 is correctly positioned, among others.

An alignment aid 204 may be displayed on a screen of the photographic device 112. The alignment aid 204 is configured to enable the photographic device 112 to correctly align the image sensor (not illustrated) to capture the image represented by image data 114. Alignment aids 204 may include cross-hairs or other design features which enable a user to correctly position the photographic device 112. The alignment aid 204 may include data which facilitates alignment of the photographic device 112 relative to the apparatus 100. For example, an alignment aid 204 may include a ghosted, transparent, or outlined view of an object. This may enable a user to appropriately align the photographic device 112 with respect to the apparatus 100.

The communicator 104 may be configured to transfer and receive data (e.g., synchronization data 106, image data 114) between other devices. The communicator 104 may communicate with the other devices via a network. The network may be a broadband wide-area network, local-area network, or a personal area network. Communication across the network may be packet, radio, or frequency/amplitude modulation based. In various examples, communicator 104 may utilize Near Field Communication (NFC) to transmit and receive data (synchronization data 106, image data 114) across the network. In other examples, communicator 104 may transmit and receive data (synchronization data 106, image data 114) utilizing Bluetooth or Wireless Fidelity (Wi-Fi). In some examples, multiple communication protocols may be utilized, such as NFC to initiate wireless connections.

Image processor 108 is coupled to communicator 104. Image processor 108 is to combine image data 114 received from the photograph device 112, for example image data 114 received via the communicator 104, with image data (not illustrated) generated by the image capture device 102 of apparatus 100. Image processor 108 may comprise a general purpose processor capable of executing machine readable instructions 110, an application specific integrated circuit (ASIC), or logic configured to perform various functions. The image processor 108, in one example, may be configured to combine image data 114 from the photographic device 112 and image data from the image capture device 102 of the apparatus 100 to generate a stereoscopic image. In another example, the image processor 108 may be configured to combine image data 114 from the photographic device 112 and image data from the image capture device 102 of the apparatus 100 to generate a video. Other manipulations, combinations, or digital signal processing may be utilized in conjunction with the image data received from either the photographic device 112 or the apparatus 100.

In various examples, after the image processor 108 has combined, manipulated, or adjusted the image data 114 from the photographic device 112 and the image data from the apparatus 100 into a combined image, series of images, or a video, the communicator 104 may transmit the result to a recipient. The recipient may be the photographic device 112 which received the synchronization data 106 and transmitted the image data 114.

Referring to FIG. 2, an illustration of synchronization data 200 is shown in accordance with an example of the present disclosure. The synchronization data 200 includes timing information 202 and an alignment aid 204. While illustrated with both the timing data 202 and the alignment aid 204, synchronization data 202 is not intended to limited in this manner. Rather, synchronization data 200 may include either the timing information 202 or the alignment aid 204, or alternatively, may include additional data.

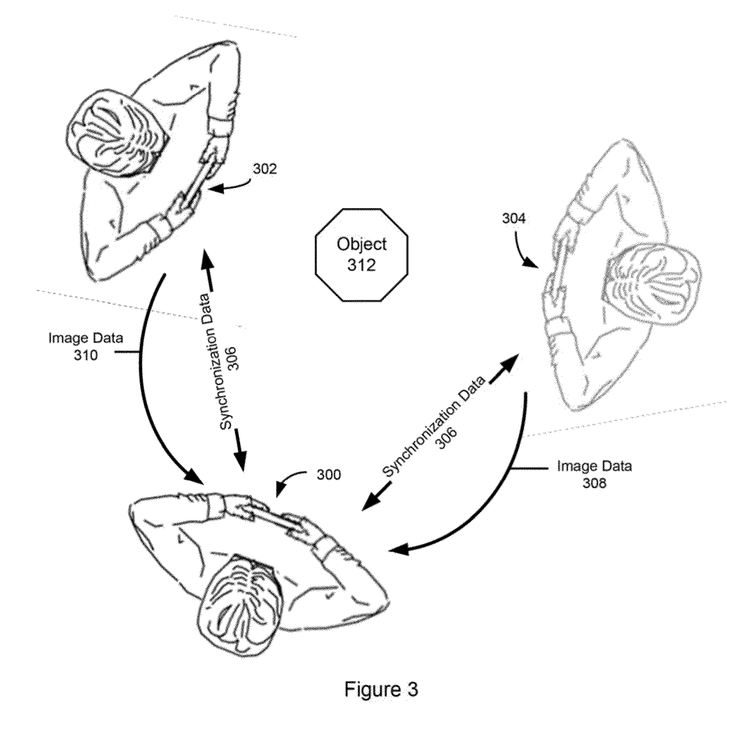

FIG. 3 illustrates an example of multiple devices cooperatively communicating to generate image data. In the illustration, three devices 300, 302, 304 are situated on various sides of an object 312. Object 312 can be any object, person, or scene capable of capture via an image capture device. The device 300 may initiate a cooperative image capture session. In this example, the device 300 may be considered a master device 300. Other devices 302, 304, which may be described as slave devices, may cooperate to generate image data 308, 310 that may be shared amongst the multiple devices 300, 302, 304. The determination of master and slave device may be user based, or determined based on various criteria, including but not limited to, the device that initiates the cooperative image, the device having a specified position, the device with the highest processing capabilities, or the device with the best image capturing capabilities, among others.

In the illustrated example, the master device 300 may establish communication links and transmit synchronization data 306 to each of the slave devices 302, 304. As stated previously, the synchronization data 306 may include timing information and/or alignment aids among other elements. Once synchronization data 306 has been appropriately distributed, and based on the synchronization data 306, devices 300, 302, 304 may each capture an image of object 312.

Once the images are captured, devices 302 and 304 may transmit image data 308, 310 to the master device 300. In other examples, image data may be distributed to other combinations of the three devices 300, 302, 304. The image data 308, 310 may represent an entire image or a portion of the image captured by the respective devices. For example, the image data 308, 310 may comprise a portion of object 312, a modified version (e.g., lower resolution) of the image captured by the respective device, or may comprise the original image captured by the respective device. The transmission of the image data 308, 310 may be via the established communication link, via another wireless protocol, or via other means, for example, an email. Once received by the master device 300, the master device 300 may perform an image processing technique to generate a combined image, a series of images, or a video, among others.

In various examples, the series of images may be viewed independently or combined to generate a video or video-like effect. For example, the series of images may be arranged so as to generate a bullet-time video effect. A bullet-time effect refers to a digitally enhanced simulation of variable-speed photography. It enables transformation of time and space within the video, and may be achieved by arranging in succession the images from different cameras. In other examples, the combined image may comprise a panoramic image, a stereoscopic image, or another type of image. Once generated, the master device 300, or the device(s) which performed the processing, may transmit the combination (e.g., image or video) or series of images to various devices, for example slave devices 302, 304.

While FIG. 3 illustrates three devices 300, 302, 304 situated within close proximity to one another, more or fewer devices may be utilized, and the devices 300, 302, 304 may be located at varying distances from one another. As an example, various devices (e.g., client/master) may be located in geographically distinct locations and may take images at distinct times as dictated by synchronization data. For example, a first device 300 may be located in a first location (i.e., a first country) and a second device 302 may be located in a second location (i.e., a second country). An object, for example the moon, may be the object at which various users wish to photograph. In such an example, various wide area networks may be utilized to transmit synchronization data, image data, and any finalized images.

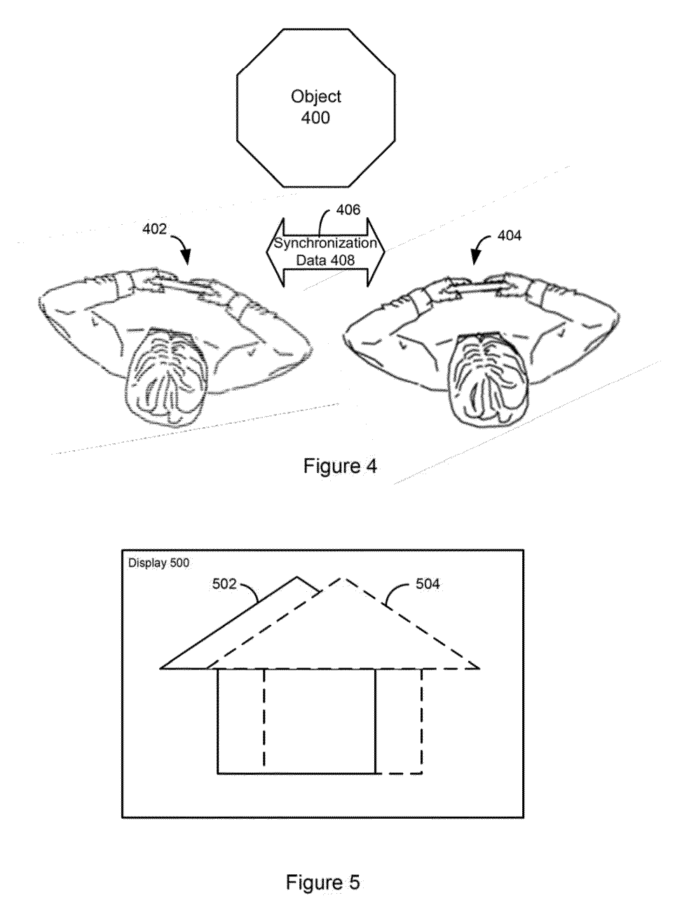

Referring to FIG. 4, another example of multiple devices cooperatively communicating to generate image data is illustrated. In FIG. 4, a first device 402 and a second device 404 are disposed about an object 400. Either user of the first device 402 or the second device 404 desires a stereoscopic image of the object 400, yet does not have the capabilities to generate such an image. Consequently, the first device 402 and the second device 404 may cooperate to generate the stereoscopic image.

In the illustration, device 402 may establish a communication link 406 with device 404. The communication link 406 may be established utilizing various communication protocols, as previously described. Synchronization data 408, image data (not illustrated), and a stereoscopic image (not illustrated) may be distributed via the communication link 406.

In the illustrated example, the synchronization data 408 includes timing information and an alignment aid. An alignment aid may be transmitted to facilitate proper alignment of the second device 404 for the stereoscopic image. The alignment aid may be determined based upon an intended depth of the image, or other characteristics of a desired stereoscopic image. The alignment aid may facilitate positioning of the second device 404 approximately three inches apart from the first device 402 while in a same plane with respect to the object 400. The timing data may indicate that the second device 404 should capture the image when the object 400 arrives at an appropriate position within the viewfinder or display of the second device 402.

Once the image is captured by the second device 404, the image data may be transferred to the first device 402 via the communication link 406 and combined to generate a finalized image. The finalized image may then be distributed to the second device 404. In another example, the finalized image may be generated utilizing distributed processing, wherein each device (e.g., first device 402, second device 404) performs various functions on the image data.

Referring to FIG. 5, an example stereoscopic image displayed on display 500 is illustrated. A first portion of the stereoscopic image 502 may have been generated by the first device 402. A second portion of the stereoscopic image 504 may have been generated by a second device 404. The offset between the first portion 502 and the second portion 504 may generate a 3D illusion when viewed. In various examples, this offset may correspond to an offset generated by the alignment aids of the synchronization data.

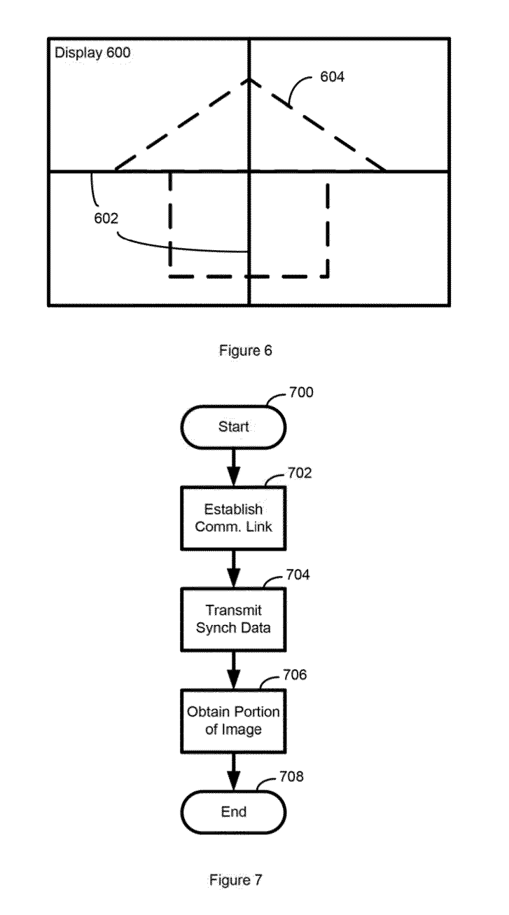

Referring to FIG. 6, an example of such an alignment aid is illustrated in accordance with an example. In FIG. 6, the alignment aid consists of cross-hairs 602. The cross-hairs may indicate a point at which the first device 402 or second device 404 should be aligned. Once aligned, an image may be generated. When the intersection of the cross-hairs arrives at a desired position an image may be captured. The image capture may be automatically triggered via a determination that the image 604 is appropriately framed with display 600. Other alignment aids, such as a portion of an image generated by a first device 402 are contemplated.

Referring to FIGS. 7-10, various flow diagrams are illustrated in accordance with the present disclosure. The flow diagrams may illustrate various elements associated with an apparatus as illustrated in FIGS. 1 and 3-4. While illustrated in a particular order, the disclosure is not so limited. Rather, it is contemplated that various ones of the elements may occur in different orders or simultaneously with other elements. Additionally, it is contemplated that the elements illustrated in FIGS. 7-10 may be embodied as programming instructions stored on a computer readable medium, which may be read and executed by a processor, for example the image processor 108 of FIG. 1.

Referring to FIG. 7, a flow diagram is illustrated in accordance with the present disclosure. The flow diagram begins at 700 and proceeds to 702 where a client device may establish a communication link with a photographic device, wherein the client device and the photographic device may capture images of an object from different perspectives. As used herein a different perspective is defined as a different location or view of the object. Establishing the communication link may comprise the photographic device being brought within a communication distance of the client device, for example, when the communication link is an NFC link. Alternatively, establishing the communication link may comprise a series of handshakes and communications to provide a secure link for transmitting data.

Upon establishing the communication link 702, the client device may transmit synchronization data to the photographic device via the communication link, 704. The synchronization data may facilitate capture of the image by the photographic device. As stated previously, the synchronization data may include timing information and/or alignment aids among other elements.

After transmission of the synchronization data 704, an image may be captured by one or more of the client devices and the photographic device. In response to an image capture by the photographic device, the client device may obtain a portion of the captured image via the communication link at 706. The obtained portion of the image may correspond to a portion of the image captured by the photographic device. The method may then end at 708.

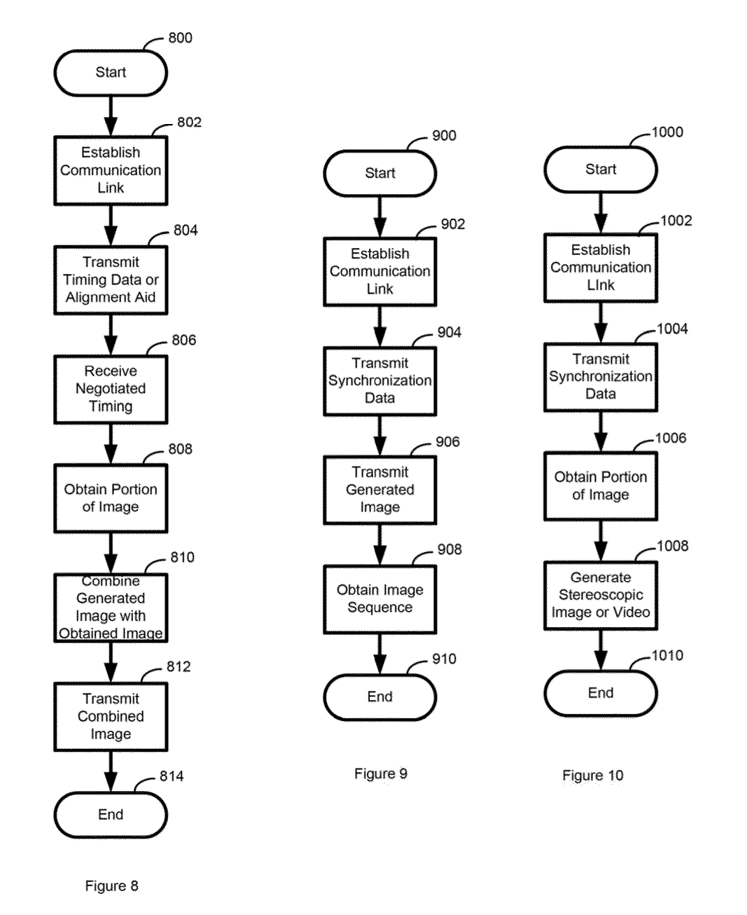

Referring to FIG. 8, another example is illustrated in accordance with the present disclosure. The flow diagram begins at 800 and progresses to 802 where a client device may establish a communication link with a photographic device. The communication link may utilize broadband, NFC, Bluetooth, or Wireless Fidelity (Wi-Fi) technology, among others.

With an established communication link, the client device may transmit synchronization data such as timing information and alignment aids to the photographic device at 804. The timing data may enable the photographic device to capture an image at a predetermined time, within a predetermined amount of time, or alternatively, when the photographic device is ready. In one example, the photographic device may transmit a negotiated timing sequence to the client device at 806. A negotiated timing sequence may indicate to the client device when the photographic device will be enabled or ready to capture an image.

Once a timing sequence has been negotiated 806, the photographic device may capture an image and transmit a portion of the image to the client device. The client device may obtain the portion of the image at 808. Obtaining a portion of the image at 808 may include receiving a desired portion of the image, the entire image, a version of the image having a lower resolution to reduce transmission bandwidth between the devices, or merely a selected portion of the captured image.

At 810, the client device may combine the obtained image data with the image obtained by the client device. In various examples, the client device may combine the image data from the photographic device and the image data from the apparatus into a video, a panoramic image, a series of photos illustrating the various perspectives, a stereoscopic image, or other image combination. Once combined, the client device may transmit the data at 812. Transmitting the data may comprise distributing the combined image to each photographic device with an established communication link. The method may then end at 814.

Referring to FIG. 9, another example of a flow diagram is illustrated in accordance with the present disclosure. The method may begin at 900 and progress to 902 where a client device may establish a communication link with a photographic device. As stated previously, the communication link may utilize wireless broadband, NFC, Bluetooth, or Wireless Fidelity (Wi-Fi) technology, among others.

With an established communication link, the client device may transmit synchronization data to the photographic device at 904. The synchronization data may include timing information and/or an alignment aid. Based on the synchronization data, the client device and the photographic device may capture an image of an object. With an image capture, the client device may transmit image data to the photographic device at 906. The client device may transmit image data to the photographic device for processing if, for example, it is determined that the photographic device is better suited for image processing.

In response to the transmission of image data to the photographic device at 906, the client device may obtain an image sequence at 908. The image sequence may be a video, a panoramic view of the object, a stereoscopic image of the object, a series of images, or another image which may be generated based on image data from the client device and the photographic device. Upon receipt of the image sequence, the method may end at 910.

Referring to FIG. 10, another flow diagram is illustrated in accordance with the present disclosure. The method may begin at 1000 and progress to 1002 where a client device may establish a communication link with a photographic device, wherein the client device and the photographic device may capture images of an object from different perspectives. Again, the communication link may utilize wireless broadband, NFC, Bluetooth, or Wireless Fidelity (Wi-Fi) technology, among others.

In response to the communication link, the client device and the photographic device may transmit, receive, and/or exchange synchronization data at 1004. The synchronization data may include timing information and/or an alignment aid. The alignment aid, in this example, may be determined based upon intended characteristics of a stereoscopic image.

Based on the synchronization data, the client device may obtain a portion of the image captured by the photographic device at 1006. In response to receipt of the portion of the image, the client device may generate a stereoscopic image, series of images, or video at 1008. The method may then end at 1010.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of this disclosure. Those with skill in the art will readily appreciate that embodiments may be implemented in a wide variety of ways. This application is intended to cover any adaptations or variations of the embodiments discussed herein. Therefore, it is manifestly intended that embodiments be limited only by the claims and the equivalents thereof.

What is claimed is:

1. A method, comprising:
establishing, by a client device, a communication link with a photographic device;
transmitting, by the client device, synchronization data to the photographic device via the communication link, wherein the synchronization data arranges capture of an image via the photographic device; and
obtaining, by the client device, a portion of the image captured via the photographic device via the communication link.

2. The method of claim 1, further comprising:
combining, by the client device, an image captured by the client device with the portion of the image captured via the photographic device to generate a combined image; and
transmitting, by the client device, the combined image to the photographic device.

3. The method of claim 1, further comprising:
transmitting, by the client device, an image captured by the client device to the photographic device; and
wherein obtaining the portion of the image captured via the photographic device comprises obtaining an image sequence from the photographic device, the image sequence including the portion of the image captured via the photographic device and a portion of the image captured by the client device.

4. The method of claim 1, wherein transmitting the synchronization data comprises transmitting timing data to control image capture via the photographic device.

5. The method of claim 4, further comprising:
receiving, by the client device, a synchronization data response, wherein the synchronization data response includes a negotiated timing sequence.

6. The method of claim 1, wherein transmitting the synchronization data comprises transmitting an alignment aid to control alignment of the photographic device.

7. The method of claim 1, further comprising:
generating, by the client device, a stereoscopic image based on an image captured by the client device and the obtained portion of the image captured via the photographic device.

8. The method of claim 1, further comprising:
generating, by the client device, a video based on an image captured by the client device and the obtained portion of the image captured via the photographic device.

9. An apparatus, comprising:
an image capture device;
a communicator coupled to the image capture device, wherein the communicator is to transmit synchronization data to a photographic device and to receive image data from the photographic device; and
a processor coupled to the communicator, wherein the processor is to generate the synchronization data to manage generation of the image data by the photographic device.

10. The apparatus of claim 9, wherein the synchronization data includes timing information to manage generation of the image data by the photographic device.

11. The apparatus of claim 9, wherein the synchronization data includes an alignment aid to manage generation of the image data by the photographic device.

12. The apparatus of claim 9, wherein the processor is to combine the image data from the photographic device and image data from the image capture device to generate a stereoscopic image.

13. The apparatus of claim 9, wherein the processor is to combine the image data from the photographic device and image data from the image capture device to generate a video.

14. The apparatus of claim 9, wherein the communicator is further to transmit a combined image comprising image data from the image capture device and the image data to the photographic device to the photographic device.

15. An article of manufacture comprising a computer readable medium having a plurality of programming instructions stored thereon, wherein the plurality of programming instructions, if executed, cause a client device to:
generate a communication link with a photographic device;
control image capture by the photographic device via the communication link; and
process an image captured by the photographic device and an image captured by the client device.

16. The article of manufacture of claim 15, wherein the plurality of programming instructions, if executed, cause the client device to:
transmit timing instructions to the photographic device to control image capture by the photographic device.

17. The article of manufacture of claim 15, wherein the plurality of programming instructions, if executed, cause the client device to:
transmit an alignment aid to the photographic device to control image capture by the photographic device.

18. The article of manufacture of claim 15, wherein the plurality of programming instructions, if executed, further cause the client device to:
transmit the image captured by the client device to the photographic device to enable distributed processing between the client device and the photographic device.

19. The article of manufacture of claim 15, wherein the plurality of programming instructions, if executed, further cause the client device to:
combine the image captured by the client device with the image captured by the photographic device to generate a stereoscopic image; and
transmit the stereoscopic image to the photographic device.

20. The article of manufacture of claim 15, wherein the plurality of programming instructions, if executed, further cause the client device to:
combine the image captured by the client device with the image captured by the photographic device to generate a video; and
transmit the video to the photographic device.
